(19) United States
(12) Patent Application Publication
(10) Pub. No.: US 2026/0124960 A1
(43) Pub. Date: May 7, 2026

(54) COOLING SYSTEM FOR VEHICLE BATTERY AND METHOD OF CONTROLLING THE SAME

(71) Applicants: HYUNDAI MOTOR COMPANY, SEOUL (KR); KIA CORPORATION, SEOUL (KR)

(72) Inventors: Qing Dong Hou, Shandong (CN); Tae Hun Jung, Hwaseong-si (KR); Xiaorui Zhai, Shandong (CN)

(73) Assignees: HYUNDAI MOTOR COMPANY, SEOUL (KR); KIA CORPORATION, SEOUL (KR)

(21) Appl. No.: 19/381,561

(22) Filed: Nov. 6, 2025

(30) Foreign Application Priority Data
Nov. 7, 2024 (CN) 202411585404.1

(51) Int. Cl. B60L 58/26; H01M 10/48; H01M 10/613; H01M 10/625; H01M 10/63

(52) U.S. Cl. CPC B60L 58/26; H01M 10/486; H01M 10/613; H01M 10/625; H01M 10/63; B60L 2240/545; B60L 2240/662

(57) ABSTRACT

A cooling system for vehicle battery and a control method thereof for a vehicle is provided. The cooling system includes an ambient temperature sensor that measures an ambient temperature. and a controller. The controller is configured to determine a battery cooling start temperature and a battery cooling end temperature based on the ambient temperature measured by the ambient temperature sensor, predict an estimated vehicle driving time, and determine a final cooling start temperature and a final cooling end temperature by adjusting the battery cooling start temperature and the battery cooling end temperature based on the predicted estimated vehicle driving time.

### CROSS-REFERENCE TO RELATED APPLICATION(S)

This application claims priority to and the benefit of Chinese Patent Application No. 202411585404.1 filed with the Chinese National Intellectual Property Administration on Nov. 7, 2024, the entire contents of which are incorporated herein by reference.

### TECHNICAL FIELD

The present disclosure relates to a cooling system for a vehicle battery and a control method thereof, and more particularly, to a cooling system for a vehicle battery and a control method thereof capable of adjusting a battery cooling strategy based on an ambient temperature and a vehicle usage mode.

### BACKGROUND

Electric vehicles are equipped with high-voltage batteries as a power source. To support the function of the high-voltage battery, a cooling system for the battery may maintain the temperature of the high-voltage battery at a (e.g., optimal) working temperature (e.g., 36° C.). When the temperature of the high-voltage battery exceeds the (e.g., optimum) operating (e.g., working) temperature, the cooling system for the battery begins to cool the high-voltage battery, thereby lowering the temperature of the high-voltage battery. A conventional battery cooling strategy does not consider ambient temperature and vehicle usage modes, which may result in increased (e.g., excessive) cooling and energy waste.

On the one hand, when the vehicle is parked in a high-temperature environment (e.g., above 40° C.) for a long period of time, the temperature of the high-voltage battery becomes almost the same as the ambient temperature. In this case, even if the driving time of the vehicle is short, the conventional cooling system for the battery cools the high-voltage battery (e.g., immediately) after the vehicle is started, thereby lowering the temperature of the high-voltage battery to an (e.g., optimal) operating temperature. However, in this case, the ambient temperature is high and the vehicle driving time is very short, making it difficult to maintain the temperature of the high-voltage battery at the (e.g., optimal) operating temperature. Therefore, using conventional battery cooling strategies result in increased (e.g., excessive) battery cooling and energy waste.

On the other hand, when the vehicle is driven in a low-temperature environment (e.g., below 0° C.), once the temperature of the high-voltage battery exceeds the (e.g., optimum) operating temperature, the conventional battery cooling system (e.g., immediately) performs cooling of the high-voltage battery, thereby lowering the temperature of the high-voltage battery to the (e.g., optimum) operating temperature. However, considering that the temperature of the high-voltage battery may naturally decrease in low ambient temperatures, using the conventional battery cooling strategy may still result in increased (e.g., excessive) battery cooling and energy waste.

The above information disclosed in this background section is meant to facilitate understanding of the background of the disclosure, and therefore, it may contain information that does not form the prior art.

### SUMMARY

An example embodiment of the present disclosure provides a cooling system for a vehicle battery and a control method thereof capable of adjusting a battery cooling strategy based on an ambient temperature and a vehicle usage mode.

According to an aspect of the present disclosure, a cooling system for a vehicle battery is provided. The cooling system includes an ambient temperature sensor that measures an ambient temperature and a controller. The controller may be configured to determine a battery cooling start temperature and a battery cooling end temperature based on the ambient temperature measured by the ambient temperature sensor, predict an estimated vehicle driving time, and determine a final cooling start temperature and a final cooling end temperature by adjusting the battery cooling start temperature and the battery cooling end temperature based on the predicted estimated vehicle driving time.

In an example embodiment of the present disclosure, the cooling system may further include a navigation device providing navigation information, and the controller may be further configured to predict the estimated vehicle driving time based on the navigation information provided by the navigation device.

In an example embodiment of the present disclosure, the cooling system may further include a storage device for storing a vehicle driving time history, and the controller may be further configured to predict the estimated vehicle driving time based on the vehicle driving time history stored in the storage device in the absence of the navigation information.

In an example embodiment of the present disclosure, the cooling system may further include a storage device storing a vehicle driving time history, and the controller may be further configured to predict the estimated vehicle driving time based on the vehicle driving time history stored in the storage device when there is no navigation information, or may be further configured to predict the estimated vehicle driving time based on the vehicle driving time history stored in the storage device even when there is navigation information.

In an example embodiment of the present disclosure, the controller may be further configured to classify an estimated vehicle driving time grade according to the predicted estimated vehicle driving time based on the navigation information or the vehicle driving time history, determine the estimated vehicle driving time grade as level 1 based on the predicted estimated vehicle driving time being less than a first scheduled time, determine the estimated vehicle driving time grade as level 2 based on the predicted estimated vehicle driving time being greater than or equal to the first scheduled time and less than a second scheduled time, and determine the estimated vehicle driving time grade as level 3 based on the predicted estimated vehicle driving time being greater than or equal to the second scheduled time and less than a third scheduled time.

In an example embodiment of the present disclosure, the controller may be further configured to, based on the determined estimated vehicle driving time grade being level 1, increase the battery cooling start temperature by a first predetermined value to be the final battery cooling start temperature, and increase the battery cooling end temperature by a second predetermined value to be the final battery cooling end temperature. The controller may be further configured to, based on the determined estimated vehicle driving time grade being level 2, increase the battery cooling start temperature by a third predetermined value to be the final battery cooling start temperature, and increase the battery cooling end temperature by a fourth predetermined value to be the final battery cooling end temperature. The controller may be further configured to, based on the determined estimated vehicle driving time grade being level 3, increase the battery cooling start temperature by a fifth predetermined value to be the final battery cooling start temperature, and increase the battery cooling end temperature by a sixth predetermined value to be the final battery cooling end temperature.

In an example embodiment of the present disclosure, the cooling system may further include a battery temperature sensor for measuring a battery temperature, and the controller may be further configured to perform battery cooling based on a current battery temperature being higher than the final battery cooling start temperature, and terminate the battery cooling based on the current battery temperature being lower than or equal to the final battery cooling termination temperature during the battery cooling.

In an example embodiment of the present disclosure, the controller may be further configured to update the vehicle driving time history stored in the storage device based on an actual driving time of the vehicle after a vehicle ignition is turned off.

According to another aspect of the present disclosure, a method for controlling a vehicle battery cooling system is provided. The method may include, by a controller, determining a battery cooling start temperature and a battery cooling end temperature based on an ambient temperature measured by an ambient temperature sensor; predicting an estimated vehicle driving time, and determining a final battery cooling start temperature and a final battery cooling end temperature by adjusting the battery cooling start temperature and the battery cooling end temperature based on the predicted estimated vehicle driving time by the controller.

In an example embodiment of the present disclosure, in predicting the estimated vehicle driving time, the controller may predict the estimated vehicle driving time based on navigation information provided by a navigation device.

In an example embodiment of the present disclosure, in predicting the estimated vehicle driving time, in the absence of the navigation information, the controller may predict the estimated vehicle driving time based on a vehicle driving time history stored in a storage device.

In an example embodiment of the present disclosure, the predicting the estimated vehicle driving time may further include classifying an estimated vehicle driving time grade according to the predicted estimated vehicle driving time based on the navigation information or the vehicle driving time history by the controller. In the classifying the estimated vehicle driving time grade, based on the predicted estimated vehicle driving time being less than a first scheduled time, the estimated vehicle driving time grade is determined as level 1. Based on the predicted estimated vehicle driving time being greater than or equal to the first scheduled time and less than a second scheduled time, the estimated vehicle driving time grade is determined as level 2. Based on the predicted estimated vehicle driving time being greater than or equal to the second scheduled time and less than a third scheduled time, the estimated vehicle driving time grade is determined as level 3.

In an example embodiment of the present disclosure, when adjusting the battery cooling start temperature and the battery cooling end temperature, based on the determined estimated vehicle driving time grade being level 1, the battery cooling start temperature is increased by a first predetermined value to be the final battery cooling start temperature, and the battery cooling end temperature is increased by a second predetermined value to be the final battery cooling end temperature. Based on the determined estimated vehicle driving time grade being level 2, the battery cooling start temperature is increased by a third predetermined value to be the final battery cooling start temperature, and the battery cooling end temperature is increased by a fourth predetermined value to be the final battery cooling end temperature. Based on the determined estimated vehicle driving time grade being level 3, the battery cooling start temperature is increased by a fifth predetermined value to be the final battery cooling start temperature, and the battery cooling end temperature is increased by a sixth predetermined value to be the final battery cooling end temperature.

In an example embodiment of the present disclosure, the method further includes, after determining the final battery cooling start temperature and the final battery cooling end temperature, performing cooling of the battery by the controller based on the current battery temperature being greater than or equal to the final battery cooling start temperature, and terminating cooling of the battery by the controller based on the current battery temperature being lower than or equal to the final battery cooling termination temperature during the cooling of the battery.

In an example embodiment of the present disclosure, the method further includes updating, by the controller, the vehicle driving time history stored in the storage device based on an actual driving time of the vehicle when a vehicle ignition is turned off.

According to an example embodiment of the present disclosure, increased (e.g., excessive) battery cooling and energy waste may be reduced or avoided by adjusting the battery cooling strategy based on the ambient temperature and the vehicle usage mode.

Further, effects that may be obtained or expected from example embodiments of the present disclosure are (e.g., directly or suggestively) described in the following detailed description. Various effects from example embodiments of the present disclosure will be described in the following detailed description.

### BRIEF DESCRIPTION OF THE DRAWINGS

The above and other objects, features and other advantages of the present disclosure may be understood through the detailed description presented herein together with the drawings.

FIG. 1 is a block diagram of a cooling system for a vehicle battery according to an example embodiment of the present disclosure.

FIG. 2 is a flowchart of a control method of a cooling system for a vehicle battery according to an example embodiment of the present disclosure.

### DETAILED DESCRIPTION

The term “vehicle” or “vehicular” or other similar terms as used herein is understood to include automobiles, private cars generally including sport utility vehicles (SUVs), buses, trucks, various commercial vehicles, watercraft including various boats and ships, aircraft, and the like, and to also include hybrid vehicles, electric vehicles, plug-in hybrid electric vehicles, hydrogen-powered vehicles and other alternative fuel vehicles (e.g., fuels derived from sources other than petroleum).

Although example embodiments are described as using multiple units to perform example processes, the example processes may be performed by one or more modules. Additionally, the term “controller/control unit” may refer to a hardware device that includes at least a memory and a processor and may be (e.g., specifically) programmed to execute the processes described herein. The memory is configured to store modules, and the processor is specifically configured to execute the (e.g., said) modules to perform one or more processes as further described below.

As used herein, singular terms are intended to include plural forms as well, unless the context clearly indicates otherwise. These terms are intended to distinguish one component from another and do not limit the nature, sequence, or order of the components. It should be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a cooling system for a vehicle battery and a control method thereof according to an example embodiment of the present disclosure will be described with reference to the attached drawings.

Typically, according to battery cooling strategies, a battery cooling start temperature Tₛₜₐᵣₜ and a battery cooling end temperature T_{end} are set to fixed values (e.g., an optimal working temperature of the battery), without considering an ambient temperature and a vehicle usage mode, which may result in increased (e.g., excessive) battery cooling and energy waste.

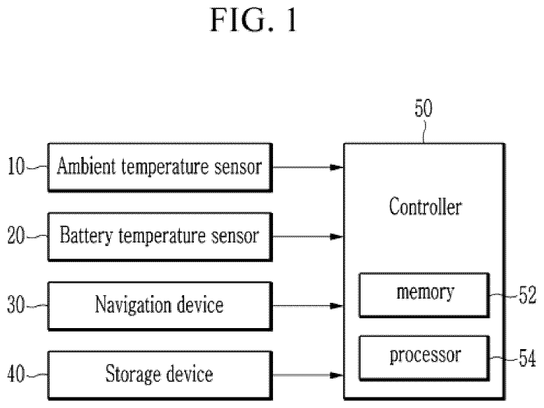

FIG. 1 is a block diagram of a cooling system for a vehicle battery according to an example embodiment of the present disclosure.

As shown in FIG. 1, a cooling system for a vehicle battery according to an example embodiment of the present disclosure may include an ambient temperature sensor 10, a battery temperature sensor 20, a navigation device 30, a storage device 40, and a controller 50. The controller includes a memory 52 that is configured to store computer-executable instructions, and at least one processor 54 that is configured to access the memory and execute the instructions.

The ambient temperature sensor 10 may measure the ambient temperature T_{amb}. The higher the ambient temperature T_{amb}, the longer it may take for the battery to cool down to the same temperature, and the faster the battery temperature may rise after the cooling for the battery stops. The ambient temperature T_{amb} (e.g., directly) impacts the battery cooling effect, so the battery cooling strategy may be adjusted according to the ambient temperature.

For example, when the ambient temperature T_{amb} is relatively high, the battery cooling start temperature Tₛₜₐᵣₜ and the battery cooling end temperature T_{end} may be set to relatively high values, thereby delaying the battery cooling start time and advancing the battery cooling end time compared to conventional battery cooling strategies. This may minimize or avoid over-cooling the battery and wasting energy. When the ambient temperature T_{amb} is relatively low, the battery temperature may be naturally lowered by the relatively low ambient temperature, so by setting the battery cooling start temperature Tₛₜₐᵣₜ to a relatively high value, the battery cooling end time may be advanced while the battery cooling start time may be delayed compared to conventional battery cooling strategies. This may minimize or avoid over-cooling the battery and wasting energy.

The battery temperature sensor 20 may measure the battery temperature T_{bat}. When the battery temperature T_{bat} is equal to or higher than the battery cooling start temperature Tₛₜₐᵣₜ, the battery cooling system starts cooling the battery, and when the battery temperature T_{bat} is equal to or lower than the battery cooling end temperature T_{end}, the battery cooling system stops cooling the battery.

A vehicle user may set a destination by using the navigation device 30, and the navigation device 30 may provide navigation information based on the destination set by the user, and the navigation information may include an expected vehicle driving distance and an expected driving time.

The storage device 40 may store a vehicle driving time history—i.e., the time that the vehicle (e.g., actually) drove (e.g., in the past). For example, the storage device 40 may store the vehicle driving time history of a predetermined number (N) of times in the past. The controller 50 may establish a vehicle usage mode based on the vehicle driving time history stored in the storage device 40, and may adjust the battery cooling strategy based on the established vehicle usage mode.

For example, the predetermined number (N) of times may be 10.

For example, if the vehicle driving times stored in the storage device 40 are (e.g., all) relatively short (e.g., within 30 min), such a vehicle usage mode may be established, and in the corresponding vehicle usage mode, the battery cooling start temperature Tₛₜₐᵣₜ, and the battery cooling end temperature T_{end} predetermined according to the ambient temperature T_{amb} are adjusted to larger values, thereby delaying the time for starting the battery cooling and advancing the time for ending the battery cooling. This minimizes or avoids increased (e.g., excessive) cooling of the battery and energy waste.

Conversely, if the vehicle driving times stored in the storage device 40 are (e.g., all) relatively long (e.g., 60 min or more), such a vehicle usage mode may be established, and in such a vehicle usage mode, the adjustments may not be performed for the battery cooling start temperature Tₛₜₐᵣₜ and the battery cooling end temperature T_{end} set according to the ambient temperature T_{amb}.

Additionally, the vehicle driving time history stored in the storage device 40 may be associated with a time zone in which the vehicle driving occurred, and the time zone in which the vehicle driving occurred indicates at which time of day the vehicle driving occurred. For example, the following data may be stored in the storage device 40, including, if the vehicle was driven for 20 minutes in the time zone from 8:00 to 9:00 and was driven for 40 minutes in the time zone from 17:00 and 18:00, the vehicle usage mode established in the controller 50 may be associated with the time zone in which the vehicle driving occurred. For example, if the vehicle driving occurs primarily in the time zones from 8:00 to 9:00 and from 17:00 to 18:00, the controller 50 may establish vehicle usage modes for each time zone and adjust the battery cooling strategy for each vehicle usage mode.

Accordingly, different from battery cooling strategies in which the battery cooling start temperature Tₛₜₐᵣₜ and the battery cooling end temperature T_{end} are set to fixed values, the cooling system for the vehicle battery according to an example embodiment of the present disclosure may adjust the battery cooling start temperature Tₛₜₐᵣₜ and the battery cooling end temperature T_{end} according to the ambient temperature and the vehicle usage mode.

For example, the controller 50 may receive the ambient temperature T_{amb} measured by the ambient temperature sensor 10 and determine the battery cooling start temperature Tₛₜₐᵣₜ and the battery cooling end temperature T_{end} based on the ambient temperature T_{amb}.

A mapping table of the ambient temperature T_{amb}, the battery cooling start temperature Tₛₜₐᵣₜ, and the battery cooling end temperature T_{end} may be stored in the storage device 40. Table 1 shows the mapping table of the ambient temperature T_{amb}, the battery cooling start temperature Tₛₜₐᵣₜ, and the battery cooling end temperature T_{end}, and a temperature unit is ° C.

TABLE 1

| | | | | | | | | | | | | | | | | |
|---|---|---|---|---|---|---|---|---|---|---|---|---|---|---|---|---|
| T_{amb} | −30 | −20 | −15 | −10 | −5 | 0 | 5 | 10 | 15 | 20 | 25 | 30 | 35 | 40 | 45 | 50 |
| Tₛₜₐᵣₜ | 42 | 42 | 41 | 39 | 37 | 36 | 36 | 36 | 36 | 36 | 36 | 36 | 38 | 40 | 42 | 42 |
| T_{end} | 34 | 34 | 34 | 34 | 34 | 34 | 34 | 34 | 34 | 34 | 34 | 34 | 36 | 38 | 40 | 40 |

Upon receiving the measured ambient temperature T_{amb}, the controller 50 may use (e.g., refer to or look up) the mapping table to determine the battery cooling start temperature Tₛₜₐᵣₜ and the battery cooling end temperature T_{end} corresponding to the ambient temperature T_{amb}.

After determining the battery cooling start temperature Tₛₜₐᵣₜ and the battery cooling end temperature T_{end}, the controller 50 may predict the expected vehicle driving time Tₑₛₜᵢₘₐₜₑ.

When the navigation device 30 is installed in the vehicle, if the user sets the destination with the navigation device 30, the controller 50 may receive the navigation information based on the destination set by the user—for example, from the navigation device 30. The controller 50 may determine the estimated driving time predicted in the navigation information as the estimated vehicle driving time Tₑₛₜᵢₘₐₜₑ predicted and determine an estimated vehicle driving time grade corresponding to the predicted estimated vehicle driving time Tₑₛₜᵢₘₐₜₑ.

If the navigation device 30 is not installed in the vehicle, or if the navigation device 30 is installed in the vehicle but the user does not set the destination with the navigation device 30, the controller 50 may receive the vehicle driving time history from, for example, the storage device 40. The controller 50 may predict the estimated vehicle driving time Tₑₛₜᵢₘₐₜₑ based on the received vehicle driving time history and determine the estimated vehicle driving time grade corresponding to the estimated vehicle driving time Tₑₛₜᵢₘₐₜₑ. Alternatively, regardless of whether the navigation information is available, the controller 50 may predict the estimated vehicle driving time Tₑₛₜᵢₘₐₜₑ based on, for example, the vehicle driving time history, and determine the estimated vehicle driving time grade corresponding to the estimated vehicle driving time Tₑₛₜᵢₘₐₜₑ.

Depending on the length of the vehicle driving time, the vehicle driving time may be divided into various (e.g., several) vehicle driving time grades.

For example, the vehicle driving time grades may be divided into three levels. If the vehicle driving time is less than a first scheduled time t₁, the controller 50 may determine the vehicle driving time grade as level 1. If the vehicle driving time is greater than or equal to the first scheduled time t₁ and less than a second scheduled time t₂, the controller 50 may determine the vehicle driving time grade as level 2. If the vehicle driving time is greater than or equal to the second scheduled time t₂ and less than a third scheduled time t₃, the controller 50 may determine the vehicle driving time grade as level 3. At this time, the vehicle driving time may be the vehicle driving time history or the estimated vehicle driving time Tₑₛₜᵢₘₐₜₑ, and accordingly, the vehicle driving time grade may be a vehicle driving time history grade or an estimated vehicle driving time grade.

For example, the first scheduled time t₁ may be 30 minutes, and the second scheduled time t₂ may be 60 minutes.

In the example embodiment, the vehicle driving time grade is divided into grades, such as three grades, but the example embodiment is not limited thereto, and the vehicle driving time may be divided into more or fewer grades depending on the length of the vehicle driving time.

A method for predicting the estimated vehicle driving time Tₑₛₜᵢₘₐₜₑ based on the vehicle driving time history and the estimated vehicle driving time grade corresponding to the estimated vehicle driving time Tₑₛₜᵢₘₐₜₑ is provided herein.

If the data of the vehicle driving time history stored in the storage device 40 is insufficient, the controller 50 may set the estimated vehicle driving time grade to level 2 by default. Although the example embodiments provide the estimated vehicle driving time grade set to level 2 (e.g., by default), the example embodiments are not limited thereto, and the estimated vehicle driving time grade may be set to a different level, such as level 1 or level 3 (e.g., by default).

Next, as the vehicle driving time history increases, when the condition for changing the estimated vehicle driving time grade is satisfied, the controller 50 may change the estimated vehicle driving time grade and may use the changed estimated vehicle driving time grade.

In an example embodiment, the changed condition of the estimated vehicle driving time grade may be a case that the vehicle driving time history grade corresponding to the vehicle driving time history of a (e.g., past) predetermined number (N) of times is (e.g., all) lower than an estimated vehicle driving time grade (e.g., currently predetermined), or the vehicle driving time history grade corresponding to the vehicle driving time history of the (e.g., past) predetermined number (N) of times is higher than the estimated vehicle driving time grade (e.g., currently predetermined).

For example, if the vehicle driving time history grade corresponding to the vehicle driving time history of the (e.g., past) predetermined number (N) of times is lower than the estimated vehicle driving time grade (e.g., currently predetermined), the controller 50 may change the vehicle driving time history grade to a lower grade. Here, the lower grade may be (e.g., mean) the vehicle driving time history grade corresponding to a predetermined number (N) of vehicle driving time histories (e.g., in the past).

In other words, if the vehicle driving time history accidentally changes, the controller 50 does not change the estimated vehicle driving time grade. The controller 50 changes the estimated vehicle driving time grade (e.g., only) when it determines that the vehicle usage mode has changed.

In another example embodiment, the controller 50 receives a predetermined number (N) of vehicle driving time histories from the storage device 40 and calculates an average value of the predetermined number (N) of vehicle driving time histories. The controller 50 sets the calculated average value as the estimated vehicle driving time Tₑₛₜᵢₘₐₜₑ and determines the estimated vehicle driving time grade corresponding to the estimated vehicle driving time Tₑₛₜᵢₘₐₜₑ. In this case, the condition for changing the estimated vehicle driving time grade may be that the vehicle driving time history grade corresponding to the calculated average value is different from the estimated vehicle driving time grade (e.g., currently) predicted.

Additionally, the storage device 40 may store the changed estimated vehicle driving time grade, and when the vehicle is driven thereafter, the controller 50 may use the changed estimated vehicle driving time grade stored in the storage device 40 as the current vehicle driving time grade.

The controller 50 predicts the estimated vehicle driving time Tₑₛₜᵢₘₐₜₑ predicted based on the navigation information or the vehicle driving time history and the estimated vehicle driving time grade corresponding to the estimated vehicle driving time Tₑₛₜᵢₘₐₜₑ, and then adjusts the determined battery cooling start temperature Tₛₜₐᵣₜ and the battery cooling end temperature T_{end} determined based on the ambient temperature T_{amb} according to the determined estimated vehicle driving time grade.

Specifically, if the determined estimated vehicle driving time grade is level 1, the controller 50 may add a first predetermined value a to the battery cooling start temperature Tₛₜₐᵣₜ to set a final battery cooling start temperature T_{final_start}, and may add a second predetermined value b to the battery cooling end temperature T_{end} to set a final battery cooling end temperature T_{final_end}. If the determined estimated vehicle driving time grade is level 2, the controller 50 may add a third predetermined value c to the battery cooling start temperature Tₛₜₐᵣₜ to set the final battery cooling start temperature T_{final_start}, and may add a fourth predetermined value d to the battery cooling end temperature T_{end} to set the final battery cooling end temperature T_{final_end}. If the determined estimated vehicle driving time grade is level 3, the controller 50 may add a fifth predetermined value e to the battery cooling start temperature Tₛₜₐᵣₜ to set the final battery cooling start temperature T_{final_start}, and may add a sixth predetermined value f to the battery cooling end temperature T_{end} to set the final battery cooling end temperature T_{final_end}.

For example, the first predetermined value a may be 0.5, the second predetermined value b may be 1, the third predetermined value c may be 0.5, the fourth predetermined value d may be 0.5, and the fifth predetermined value e and the sixth predetermined value f may be 0 (i.e., the battery cooling start temperature Tₛₜₐᵣₜ and the battery cooling end temperature T_{end} set according to the ambient temperature T_{amb} are not adjusted).

After determining the final battery cooling start temperature T_{final_star} and the final battery cooling end temperature T_{final_end}, the controller 50 may compare the final battery cooling start temperature T_{final_star} with the current battery temperature That measured by the battery temperature sensor 20. If the current battery temperature T_{bat} is higher than or equal to the final battery cooling start temperature T_{final_start}, the controller 50 may control the battery cooling system to proceed with battery cooling.

During the battery cooling process, the controller 50 may compare the final battery cooling end temperature T_{final_end} with the current battery temperature That measured by the battery temperature sensor 20. If the current battery temperature T_{bat} is lower than or equal to the final battery cooling end temperature T_{final_end}, the controller 50 may control the battery cooling system to stop cooling the battery.

After the vehicle engine is turned off, the controller 50 stores the actual driving time of the vehicle in the storage device 40 to create the vehicle driving time history, thereby updating the vehicle driving time history stored in the storage device 40.

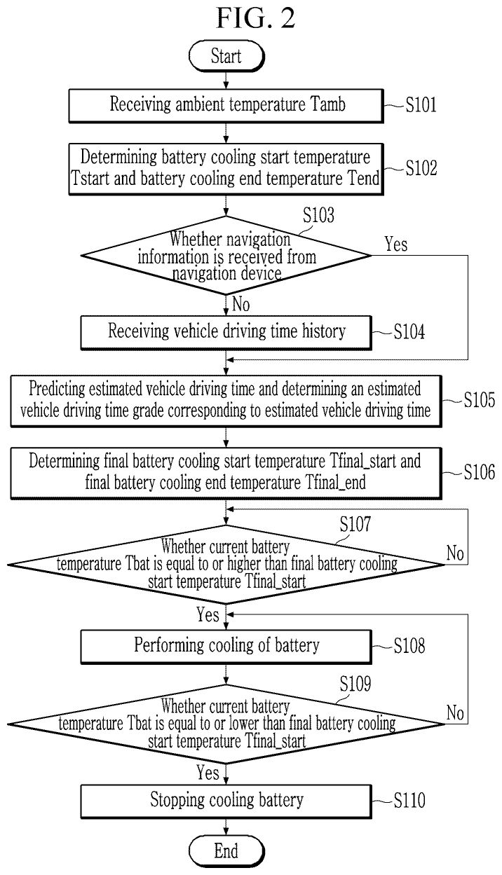

FIG. 2 is a flowchart of a control method of a cooling system for a vehicle battery according to an example embodiment of the present disclosure. Steps S101 to S110 may be performed through the cooling system for the vehicle battery illustrated in FIG. 1.

As shown in FIG. 2, in step S101, the controller 50 may receive an ambient temperature T_{amb} measured by an ambient temperature sensor 10.

In step S102, the controller 50 may determine the battery cooling start temperature Tₛₜₐᵣₜ and the battery cooling end temperature T_{end} corresponding to the measured ambient temperature T_{amb} by checking (e.g., using) a mapping table.

In step S103, the controller 50 may determine whether the navigation information may be received from the navigation device 30.

If it is determined that the navigation information has been received from the navigation device 30 (“Yes” in step S103), in step S105, the controller 50 may determine the estimated driving time included in the navigation information as the predicted estimated vehicle driving time Tₑₛₜᵢₘₐₜₑ and determine the estimated vehicle driving time grade corresponding to the estimated vehicle driving time Tₑₛₜᵢₘₐₜₑ.

Specifically, if the predicted estimated vehicle driving time Tₑₛₜᵢₘₐₜₑ is less than the first estimated time t₁, the controller 50 may determine the vehicle driving time grade as level 1. If the predicted estimated vehicle driving time Tₑₛₜᵢₘₐₜₑ is greater than or equal to the first estimated time t₁ and less than the second estimated time t₂, the controller 50 may determine the vehicle driving time grade as level 2. If the predicted estimated vehicle driving time Tₑₛₜᵢₘₐₜₑ is greater than or equal to the second estimated time t₂, the controller 50 may determine the vehicle driving time grade as level 3.

For example, the first scheduled time t₁ may be 30 min, and the second scheduled time t₂ may be 60 min.

Further, if it is determined that navigation information has not been received from the navigation device 30 (“No” in step S103), in step S104, the controller 50 may receive the vehicle driving time history from the storage device 40.

The vehicle driving time history may refer to a vehicle driving time history of a predetermined number (N) of times (e.g., immediately) preceding the current vehicle driving. For example, the predetermined number (N) of times may be 10.

Additionally, the vehicle driving time history stored in the storage device 40 may be associated with the time zone in which the vehicle driving occurred, and the time zone in which the vehicle driving occurred may indicate at which time zone of the day the vehicle driving occurred. As an example, the following data, such as the vehicle was driven for 20 minutes in the time zone from 8:00 to 9:00 and for 40 minutes in the time zone from 5:00 to 6:00, may be stored in the storage device 40.

Accordingly, when predicting the estimated vehicle driving time based on the vehicle driving time history, the vehicle driving time history of the time period corresponding to the current vehicle driving occurrence time period may be retrieved from the storage device 40.

In step S105, the controller 50 may predict the estimated vehicle driving time estimate Tₑₛₜᵢₘₐₜₑ based on the received vehicle driving time history time zone, and determine the estimated vehicle driving time grade corresponding to the estimated vehicle driving time Tₑₛₜᵢₘₐₜₑ.

In another example embodiment, the controller 50 may skip step S103 and directly perform step S104.

Specifically, if the data of the vehicle driving time history stored in the storage device 40 is insufficient, the controller 50 may set the estimated vehicle driving time grade to level 2 by default.

As the vehicle driving time history data increases, in one example embodiment, if the vehicle driving time history grades corresponding to the vehicle driving time history of the past predetermined number (N) of times are all determined to be greater than the estimated vehicle driving time grade (e.g., currently) set, or if the vehicle driving time history grades corresponding to the vehicle driving time history of the past predetermined number (N) of times are all determined to be less than the estimated vehicle driving time grade (e.g., currently) set, the controller 50 may change the estimated vehicle driving time grade to the vehicle driving time history grade corresponding to the vehicle driving time history of the past predetermined number (N) of times.

As the amount of the data of the vehicle driving time history increases, in another example embodiment, the controller 50 may receive a predetermined number (N) of the vehicle driving time histories from the storage device 40 and calculate an average value of the predetermined number (N) of the vehicle driving time histories. The controller 50 may use the calculated average value as the estimated vehicle driving time Tₑₛₜᵢₘₐₜₑ and determine the estimated vehicle driving time grade corresponding to the estimated vehicle driving time Tₑₛₜᵢₘₐₜₑ.

When the expected vehicle driving time grade is determined, in step (S106), the controller 50 may adjust the battery cooling start temperature Tₛₜₐᵣₜ and the battery cooling end temperature T_{end} determined based on the ambient temperature T_{amb} according to the determined expected vehicle driving time grade, thereby determining the final battery cooling start temperature T_{final_start} and the final battery cooling end temperature T_{final_end}.

If the determined estimated vehicle driving time grade is level 1, the controller 50 may increase the battery cooling start temperature Tₛₜₐᵣₜ by a first predetermined value a to be set as the final battery cooling start temperature T_{final_start}, and may increase the battery cooling end temperature T_{end} by a second predetermined value b to be set as the final battery cooling end temperature T_{final_end}. If the determined estimated vehicle driving time grade is level 2, the controller 50 may increase the battery cooling start temperature Tₛₜₐᵣₜ by a third predetermined value c to be set as the final battery cooling start temperature T_{final_start}, and may increase the battery cooling end temperature T_{end} by a fourth predetermined value d to be set as the final battery cooling end temperature T_{final_end}. If the determined estimated vehicle driving time grade is level 3, the controller 50 may increase the battery cooling start temperature Tₛₜₐᵣₜ by a fifth predetermined value e to be set as the final battery cooling start temperature T_{final_start}, and may increase the battery cooling end temperature T_{end} by a sixth predetermined value f to be set as the final battery cooling end temperature T_{final_end}.

For example, the first predetermined value a may be 0.5, the second predetermined value b may be 1, the third predetermined value c may be 0.5, the fourth predetermined value d may be 0.5, and the fifth predetermined value e and the sixth predetermined value f may be 0 (i.e., no adjustment is made for the battery cooling start temperature Tₛₜₐᵣₜ and the battery cooling end temperature T_{end} set by the ambient temperature T_{amb}).

If the current battery temperature T_{bat} is higher than the final battery cooling start temperature T_{final_start} (“Yes” in step S107), in step S108, the controller 50 may control the battery cooling system to perform cooling on the battery.

If the current battery temperature T_{bat} is lower than the final battery cooling start temperature T_{final_start} (“No” in step S107), the controller may (e.g., continuously) measure the battery temperature T_{bat} by repeating step 107.

While cooling the battery, at step S109, the controller 50 may determine whether the battery temperature T_{bat} is lower than or equal to the final battery cooling end temperature T_{final_end}.

If the current battery temperature T_{bat} is lower than or equal to the final battery cooling start temperature T_{final_start} (“Yes” in step S109), in step S110, the controller 50 may control the battery cooling system to stop cooling the battery.

If the current battery temperature T_{bat} is higher than the final battery cooling end temperature T_{final_end} (“No” in step S109), the controller 50 returns to step S108 and controls the battery cooling system to continue cooling the battery.

The cooling system for the vehicle battery and the control method thereof according to an example embodiment of the present disclosure may minimize or avoid increased (e.g., excessive) battery cooling and energy waste by adjusting the battery cooling strategy based on the ambient temperature and the vehicle usage mode.

While this disclosure has been described in connection with example embodiments, the disclosure is not limited to the example embodiments. Rather, the disclosure is intended to cover various modifications and equivalent arrangements.

What is claimed is:

1. A cooling system for a vehicle battery comprising:
an ambient temperature sensor that measures an ambient temperature; and
a controller including a memory storing computer-executable instructions and at least one processor configured to access the memory and execute the instructions, wherein the instructions comprise:
determining a battery cooling start temperature and a battery cooling end temperature based on the ambient temperature measured by the ambient temperature sensor;
predicting an estimated vehicle driving time; and
determining a final cooling start temperature and a final cooling end temperature by adjusting the battery cooling start temperature and the battery cooling end temperature based on the predicted estimated vehicle driving time.

2. The cooling system of claim 1, further comprising a navigation device providing navigation information,
wherein the instructions further comprise predicting the estimated vehicle driving time based on the navigation information provided by the navigation device.

3. The cooling system of claim 2, further comprising a storage device for storing a vehicle driving time history,
wherein the instructions further comprise predicting the estimated vehicle driving time based on the vehicle driving time history stored in the storage device in the absence of the navigation information.

4. The cooling system of claim 1, further comprising a storage device for storing a vehicle driving time history,
wherein the instructions further comprise predicting the estimated vehicle driving time based on the vehicle driving time history stored in the storage device.

5. The cooling system of claim 2, further comprising a storage device storing a vehicle driving time history,
wherein the instructions further comprise predicting the estimated vehicle driving time based on the vehicle driving time history stored in the storage device, and
wherein instructions further comprise classifying an estimated vehicle driving time grade according to the predicted estimated vehicle driving time based on the navigation information or the vehicle driving time history,
determining the estimated vehicle driving time grade as level 1 based on the predicted estimated vehicle driving time being less than a first scheduled time,
determining the estimated vehicle driving time grade as level 2 based on the predicted estimated vehicle driving time being greater than or equal to the first scheduled time and less than a second scheduled time, and
determining the estimated vehicle driving time grade as level 3 based on the predicted estimated vehicle driving time being greater than or equal to the second scheduled time and less than a third scheduled time.

6. The cooling system of claim 5, wherein the instructions further comprise:
based on the determined estimated vehicle driving time grade being level 1, increasing the battery cooling start temperature by a first predetermined value to be the final battery cooling start temperature, and increasing the battery cooling end temperature by a second predetermined value to be the final battery cooling end temperature;
based on the determined estimated vehicle driving time grade being level 2, increasing the battery cooling start temperature by a third predetermined value to be the final battery cooling start temperature, and increasing the battery cooling end temperature by a fourth predetermined value to be the final battery cooling end temperature; and
based on the determined estimated vehicle driving time grade being level 3, increasing the battery cooling start temperature by a fifth predetermined value to be the final battery cooling start temperature, and increasing the battery cooling end temperature by a sixth predetermined value to be the battery cooling end temperature of the battery.

7. The cooling system of claim 6, further comprising a battery temperature sensor for measuring a battery temperature,
wherein the instructions further comprise:
performing battery cooling based on a current battery temperature being higher than the final battery cooling start temperature; and
terminating the battery cooling based on the current battery temperature being lower than or equal to the final battery cooling end temperature during the battery cooling.

8. The cooling system of claim 3, wherein the instructions further comprise updating the vehicle driving time history stored in the storage device based on an actual driving time of the vehicle after a vehicle ignition is turned off.

9. The cooling system of claim 4, wherein the instructions further comprise updating the vehicle driving time history stored in the storage device based on an actual driving time of the vehicle after a vehicle ignition is turned off.

10. A method for controlling a cooling system for a vehicle battery comprising:
determining, via a controller, a battery cooling start temperature and a battery cooling end temperature based on an ambient temperature measured by an ambient temperature sensor;
predicting, via the controller, an estimated vehicle driving time; and
determining, via the controller, a final battery cooling start temperature and a final battery cooling end temperature by adjusting the battery cooling start temperature and the battery cooling end temperature based on the calculated estimated vehicle driving time via the controller.

11. The method of claim 10, wherein
predicting the estimated vehicle driving time includes predicting, via the controller, the estimated vehicle driving time based on navigation information provided by a navigation device.

12. The method of claim 11, wherein
predicting the estimated vehicle driving time includes predicting, via the controller, in the absence of the navigation information, the estimated vehicle driving time based on a vehicle driving time history stored in a storage device.

13. The method of claim 10, wherein
predicting the estimated vehicle driving time includes predicting, via the controller, the estimated vehicle driving time based on a vehicle driving time history stored in a storage device.

14. The method of claim 11, wherein:
predicting the estimated vehicle driving time, via the controller, includes predicting the estimated vehicle driving time based on a vehicle driving time history stored in a storage device;
classifying an estimated vehicle driving time grade according to the predicted estimated vehicle driving time based on the navigation information or the vehicle driving time history via the controller;
determining the estimated vehicle driving time grade is determined as level 1 when the predicted estimated vehicle driving time is less than a first scheduled time;
determining the estimated vehicle driving time grade is determined as level 2 when the predicted estimated vehicle driving time is greater than or equal to the first scheduled time and less than a second scheduled time; and
determining the estimated vehicle driving time grade is determined as level 3 when the predicted estimated vehicle driving time is greater than or equal to the second scheduled time and less than a third scheduled time.

15. The method of claim 14, wherein,
when adjusting the battery cooling start temperature and the battery cooling end temperature based on the determined estimated vehicle driving time grade being level 1,
the battery cooling start temperature is increased by a first predetermined value to be the final battery cooling start temperature, and
the battery cooling end temperature is increased by a second predetermined value to be the final battery cooling end temperature.

16. The method of claim 15, wherein,
when adjusting the battery cooling start temperature and the battery cooling end temperature based on the determined estimated vehicle driving time grade being level 2,
the battery cooling start temperature is increased by a third predetermined value to be the final battery cooling start temperature, and
the battery cooling end temperature is increased by a fourth predetermined value to be the final battery cooling end temperature.

17. The method of claim 16, wherein,
when adjusting the battery cooling start temperature and the battery cooling end temperature based on the determined estimated vehicle driving time grade being level 3,
the battery cooling start temperature is increased by a fifth predetermined value to be the final battery cooling start temperature, and
the battery cooling end temperature is increased by a sixth predetermined value to be the final battery cooling end temperature.

18. The method of claim 17, further comprising:
after determining the final battery cooling start temperature and the final battery cooling end temperature,
performing cooling of the battery via the controller based on a current battery temperature being greater than or equal to the final battery cooling start temperature; and
terminating cooling of the battery via the controller based on the current battery temperature being lower than or equal to the final battery cooling end temperature during the cooling of the battery.

19. The method of claim 12, further comprising:
updating, via the controller, the vehicle driving time history stored in the storage device based on an actual driving time of the vehicle when a vehicle ignition is turned off.

20. The method of claim 13, wherein:
updating, via a controller, the vehicle driving time history stored in the storage device based on an actual driving time of the vehicle when a vehicle ignition is turned off.
